(19) United States
(12) Patent Application Publication
(10) Pub. No.: US 2020/0331188 A1
(43) Pub. Date: Oct. 22, 2020

(54) LONG FLEXIBLE TUBING ELEMENT (VARIANTS)

(71) Applicant: UCT TECHNOLOGIES LIMITED LIABILITY COMPANY [RU/RU], Moscow (RU)

(72) Inventor: Rivener Musavirovich GABDULLIN, Moscow (RU)

(73) Assignee: UCT TECHNOLOGIES LIMITED LIABILITY COMPANY [RU/RU], Moscow (RU)

(21) Appl. No.: 16/957,737

(22) PCT Filed: Jan. 11, 2019
(86) PCT No.: PCT/RU2019/000006

§ 371 Date: Jun. 25, 2020

(30) Foreign Application Priority Data
Jan. 22, 2018 (RU) 2018102370

(51) Int. Cl. B29C 53/48; F16L 11/22

(52) U.S. Cl. CPC B29C 53/48; E21B 17/01; F16L 11/22

(57) ABSTRACT

The invention relates to long, flexible tubing which can be wound on a spool (coiled tubing or flexible production tubing), and comprises two closed channels combined in a single structure, said channels being formed from a single strip by repeated and successive shaping and welding, and being joined to one another by a connecting, jointing or dividing partition. A connecting partition is perforated, and has mounted thereon a flexible service belt having locking connecting cams which correspond to matching locking holes on the perforated connecting partition. The service belt has electrical cables, wires, capillary tubing, and fiber optic lines arranged therein, and the interval between the connecting cams is twice the size of the interval between the holes on the perforated connecting partition. If the closed channels are joined by an jointing partition, then a pipe-in-pipe design variant is used. If the closed channels are joined by a dividing partition, then the latter also forms part of the wall of both closed channels. The dividing partition can be twice the thickness of the strip. The weld seams, the centers of the closed channels and the partition are situated on a midline of a cross section of the string, parallel to the axis of a spool. The proposed invention makes it possible to significantly increase the potential of coiled tubing units and of the coiled tubing itself by virtue of being multi-channeled and, as a result, multi-functional.

### FIELD OF THE INVENTION

The invention relates to long-dimensional flexible tubes (coiled tubing or lengthy flexible tubing), more specifically, reel spoolable coiled tubing.

### BACKGROUND

As practice of coiled tubing application in boreholes shows, it is reasonable to have multi-channel umbilical coiled tubing with various diameters, designs, and auxiliary service channels for implementation of many technological operations inside boreholes as well as reservoir fluid lifting using different artificial lift methods. Multi-channel umbilical coiled tubing is needed also in geotechnical engineering, in particular, in production processes based on conversion of solid minerals into a mobile state (for example, liquid or friable) in order for delivering to surface by tubular strings inside boreholes.

A multi-channel coiled tubing is known comprising several hydraulic and electrical channels, which are enclosed together in a single fused shell extruded from a polymer material with two flat surfaces for easy spooling. The extruded enclosure from polymeric material around the hydraulic and electrical channels forms a single multi-channel string in the shape of a long-dimensional flexible tape, which provides good protection for the hydraulic and electrical channels. Specific quantities and diameters of electric and hydraulic channels depend on whether electrical centrifugal submersible pump or hydraulic downhole pump is used. The hydraulic channels may comprise standard coiled tubing, standard plastic long-dimensional flexible pipes, or capillary tubes while electrical and information channels may comprise electrical wires or cables and fiber-optic lines (U.S. Pat. No. 8,459,965 issued Jun. 11, 2013).

One disadvantage of above-mentioned multi-channel umbilical coil tubing consists in increased weight of the multi-channel string due to deposited plastic. Another disadvantage is necessity to cut through the solid plastic enclosure in order to repair or replace a damaged electric line section (breakdown, earth fault, etc.) or fiber-optic or capillary line section (disrupted channel) followed by re-welding of plastic. In addition, deep and long scratches or abrasions on outer surface of plastic adversely affect the tightness of stripper (annular seal) and blowout preventer equipment.

A multi-channel umbilical ArmorPak long flexible tubing and method of its assembly by installing permanent weld clamps on joints of standard flexible tubes (coil tubing) are known (www.cjstech.com). The multi-channel umbilical ArmorPak long coil tubing string is coiled off from the reel of coil tubing rig into a borehole to perform downhole operations or lifting of well fluid using, for example, submersible electric centrifugal pumps or hydraulic downhole pumps. If needed, additional standard flexible tubes (coil tubing) can be installed in the multi-channel umbilical long-dimensional ArmorPak flexible piping system either separately or inside desired channels.

Principal disadvantage of above mentioned configurable multi-channel umbilical flexible tubing is stepwise change in cross-section geometry of the string in the place of permanent weld clamps installation, which impairs integrity of the multi-channel umbilical coiled tubing system and its ability to pass through the stripper and blowout preventer. As a result, sealing ability of well equipment degrades and its service life decreases. The multi-channel umbilical flexible tubing also encounters technical difficulties in assembling a configuration with three or more service channels and spooling it on a reel.

A multi-channel umbilical flexible tubing and method of its producing that includes placing one or few long-dimensional service channels, designed to deliver electrical energy, hydraulic energy, or fluids to a well and receiving borehole information on the surface, into a larger main coiled tubing, which is formed by wrapping a metal strip around the insulated service channel(s) and thereafter welding longitudinal edges of the metal strip (U.S. Pat. No. 8,925,627 issued Jan. 6, 2015) is also known and may be considered as the closest prior art.

Disadvantages of the aforementioned multi-channel umbilical flexible tubing are related with increased weight, rigidity and cost of the string due to placing all channels inside the main outer large diameter coil tubing, which has to bear all the weight of multi-channel string when being suspended on injector head, thereby causing the necessity to increase wall thickness of the coil tubing and use steels of higher grades. Besides, a difficulty arises with suspension and sealing of free internal channels of the string in the wellhead. If the metal strip is used with a welded internal support (brackets), the multi-channel string becomes more expensive due to complicated manufacturing process and significantly more rigid at spooling on a reel owing the internal supports occupying the radial positions.

### SUMMARY OF THE INVENTION

Therefore, it is the object of the present invention to provide a reliable element of a umbilical flexible tubing produced from a single metal strip and comprising two or more isolated channels with various diameters, cross-section geometries, and configurations, which could be loosely wound (coiled) on a standard reel.

The aim of this invention is to produce a multi-channel umbilical flexible tubing using a multi-stage shaping and welding of metal strip into a suitable geometry that matches to a desired well technology or artificial lifting method and enables to arrange weld seams, connecting, jointing and dividing partitions, thick parts of the string on the string midline as well as additional detachable service (process) channels inside or outside the multi-channel umbilical flexible tubing.

According to present invention, the stated problem is solved, and the stated aim is achieved, in an element of a lengthy umbilical flexible tubing, comprising at least two isolated channels, integrated into a single structure, wherein the isolated channels are joined together by a connecting partition, wherein the isolated channels and the connecting partition are formed from a single metal strip by shaping from both edges of the metal strip and/or from a center of the metal strip by bending the metal strip longitudinally with formation of walls of the isolated channels followed by subsequent welding of the longitudinal edges to the shaped metal strip, and wherein the connecting partition is made with holes (perforated).

In some embodiments, welded seams, the connecting partition and central axes of the isolated channels are located on a midline of a cross section of the tubing.

In some embodiments, the flexible service belt with connecting locking cams is mounted on the connecting partition, wherein locking cams coincide with the holes on the connecting partition, and the cams and holes form a locking element, and wherein the service belt is configured in such a way that electrical cables, wires, capillary tubes, fiber optic lines are placed therein.

In some embodiments, a distance (spacing) between two neighboring locking cams is at least two times longer than a distance between two neighboring holes in the connecting partition.

Also, according to present invention, the stated problem is solved, and the stated aim is achieved, by an element of a lengthy umbilical flexible tubing, comprising two isolated channels integrated into a single structure, wherein the isolated channels are joined together by a dividing partition, wherein the isolated channels and the dividing partition are formed from a single metal strip by bending the metal strip longitudinally with formation of walls of the isolated channels having a semi-circle form in cross-section and the dividing partition followed by subsequent welding of the longitudinal edges to the bended shaped metal strip.

In some embodiments, the dividing partition is simultaneously a part of the walls of both isolated channels, and the dividing partition and welded seams are located on a midline of a cross section of the tubing.

In some embodiments, the dividing partition has a thickness that is about twice of a thickness of the metal strip.

Also, according to present invention, the stated problem is solved, and the stated aim is achieved, by an element of a lengthy umbilical flexible tubing, comprising two isolated channels integrated into a single structure, wherein the isolated channels are joined together by a jointing partition, wherein the isolated channels and the jointing partition are formed from a single metal strip by shaping from a center of the metal strip by bending the metal strip longitudinally with formation of an inner isolated channel followed by subsequent welding of contacting parts of the metal strip with formation of the jointing partition, and then shaping a remaining part of the metal strip with formation of an outer isolated channel followed by subsequent welding of longitudinal edges of the metal strip to the jointing partition.

Also, according to present invention, the stated problem is solved, and the stated aim is achieved, by an element of a lengthy umbilical flexible tubing, comprising two isolated channels integrated into a single structure, wherein the isolated channels are joined together by a jointing partition, wherein the isolated channels and the jointing partition are formed from a single metal strip by shaping from an edge of the metal strip with formation of an inner isolated channel followed by subsequent welding of contacting parts of the metal strip with formation of the jointing partition, and then shaping a remaining part of the metal strip with formation of an outer isolated channel followed by subsequent welding of longitudinal edges of the metal strip to the jointing partition.

### BRIEF DESCRIPTION OF THE DRAWINGS

The present summary is illustrated by the cross-sectional drawings of elements of umbilical flexible tubing. Welding operations are conducted along longitudinal lines of the metal strip, welding locations are indicated by bold arrows, the order of welding sequence is shown by bold Roman numerals, the welding seam on the cross section is shown by a bold line.

FIG. 1 shows an element of umbilical flexible tubing with single-sided welding.

FIG. 2 shows an element of umbilical flexible tubing with double-sided welding.

FIG. 3 shows an element of umbilical flexible tubing with three-sided welding.

FIG. 4 shows an element of umbilical flexible tubing with four-sided welding.

FIG. 5 shows an element of umbilical flexible tubing with a service belt attached by its locking cams to holes in perforated partition.

FIG. 6 shows an element of umbilical flexible tubing with a dividing partition.

FIG. 7 shows an element of umbilical flexible tubing with a double dividing partition.

FIG. 8 shows initial phase of manufacturing an element of a two-channel umbilical flexible tubing in the form of “pipe in pipe”.

FIG. 9 shows final phase of manufacturing an element of a two-channel umbilical flexible tubing in the form of “pipe in pipe”.

FIG. 10 shows element of two-channel umbilical flexible tubing in the form of “pipe in pipe” with an outside tube of elliptical cross-section.

FIG. 11 shows initial phase of manufacturing an element of a two-channel umbilical flexible tubing in the form of “pipe in pipe” with edges welded to jointing partition.

FIG. 12 shows final phase of manufacturing an element of a two-channel umbilical flexible tubing in the form of “pipe in pipe” with edges welded to jointing partition.

### DETAILED DESCRIPTION OF THE INVENTION

An element of a umbilical flexible tubing consists of a single profiled metal strip (roll of a long-dimensional metal strip) with welded edges, the process of manufacturing the single-strip element of a umbilical flexible tubing consisting of one or several successive stages of shaping and welding. Embodiments of element of a umbilical flexible tubing and method of manufacture are presented below.

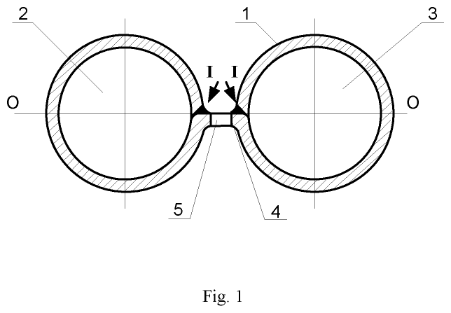

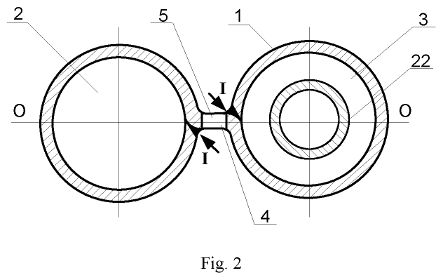

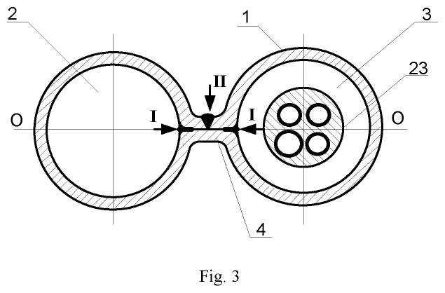

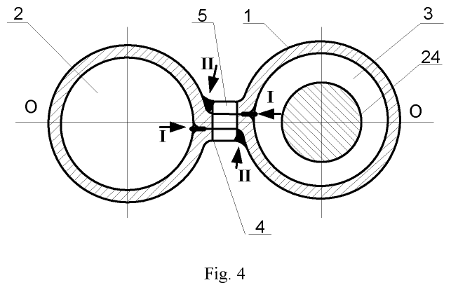

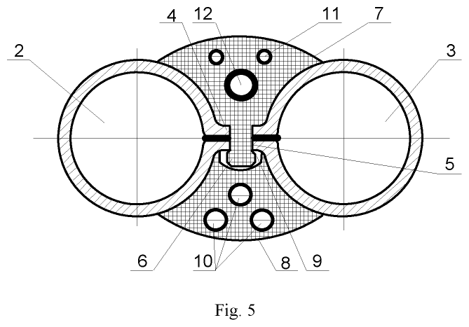

First embodiment of the element of umbilical flexible tubing (FIGS. 1 to 4) is made of a single metal strip 1 using a process including stages of shaping the strip; forming channels and partition by a series of rollers from both edges or from the middle of the strip 1 and subsequent welding of longitudinal edges to the body of shaped strip 1 with formation of two isolated cylindrical channels 2 and 3 of the same or different diameters and connecting partition 4, the thickness of partition being equal to the thickness of strip 1. Longitudinal edges of the shaped strip 1 are welded to the body of the shaped strip 1 from either one side (FIG. 1) or two sides (FIG. 2). Alternatively, as FIG. 3 shows, longitudinal edges can be butt welded to each other after pre-welding lateral sides of longitudinal edges to the body of shaped strip 1 to form a partition 4 with thickness equal to double strip thickness. Also, as FIG. 4 shows, longitudinal edges can be welded to the wall of opposite isolated cylindrical channel after pre-welding lateral sides of longitudinal edges to the body of shaped strip 1 to form a partition 4 with thickness equal to triple strip thickness. In all above cases, two isolated channels 2 and 3 and partition 4 are formed, centers of isolated channels 2 and 3, welding seams, and partition 4 being located on a single line parallel to the reel axis. Partition 4 between isolated channels 2 and 3 is in fact an outer connecting partition and can be perforated to form holes 5 of circular, elliptical, hexagonal, or any another shape (see FIG. 1). Holes 5, as FIG. 5 shows, serve as elements of a lock joint when combined with cams 6 on the elastic service belt 7, which can have shape of elastic knobs or mushrooms, for example. Contour of thickened portions of cams 6, or mushroom caps, must coincide with the contour of holes 5, but is larger in size by a factor determined by elasticity of material of the service belt 7. Spatial shape of cams 6 may be conical, spherical, etc., while the head of cam 6 may partially protrude to the opposite side of partition 4 (in such cases opposite elastic service belt 8 with service channels must have mating recesses 9 able to accommodate protruding parts of cams 6 of the first service belt 7) or be flush with the partition. The number of holes 5 may be, for example, twice the number of cams 6, which allows to arrange a similar elastic service belt 8 on opposite side of the connecting partition 4 with one-hole offset in relation to the partition 4. Service belt 7, if used as a service channel, may bear electrical conductors 10 such as cables or wires, fiber-optic lines 11, capillary tubes 12, etc. In the event of breaking, crushing, rupture of one of the channels 2 or 3, the two-channel string may be divided by a longitudinal cutting along the partition 4. Thereafter, two similar channels, suitable for further operation and separated from the rejected channels, can be welded together along the partition 4 to restore the initial element of the umbilical flexible tubing. Consequently, the partition 4 is designed for rigid connection of two hydraulic channels; at least partial relief of tubing due to injector tracks pressure and string weight transfer from tubing body to the partition 4 owing to injector gear load-carrying elements entering to holes 5 of the partition 4; optional application of elevators with fingers designed to enter to holes 5 of the partition 4; optional easy and reliable installation of additional service channels into the elastic tape 7 and/or 8 on partition 4 during tripping in hole (TIH) and easy and reliable detachment installed channels during tripping out of hole (TOH); and possible repair of long string (by means of cutting off rejected channels along partitions 4 and re-welding operable tubes in their places). Additional load-carrying metal tapes (not shown) can be welded or riveted to the partition 4 from one or both sides if working with deep boreholes or heavy strings to transfer most or all of injector tracks pressure and string weight from the tube body to the partition 4, which will increase service life of isolated channels and the string itself. One of isolated channels can be used to accommodate: (a) additional enclosed hydraulic channels 22 of the “pipe in pipe” type for submersible hydraulic pump, (b) long-dimensional rod 23 in an oil bath for submersible plunger or screw pump, or (c) electric power cable 24 with a capillary tube in an oil bath for submersible centrifugal or screw pump. In all three of above cases, the oil can be used to lubricate friction parts of submersible equipment.

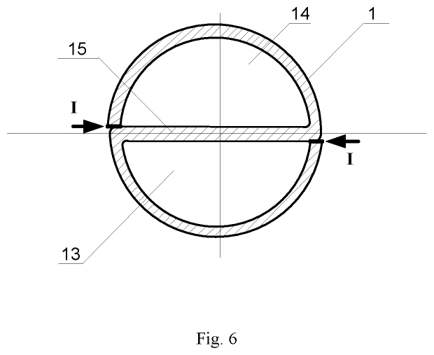

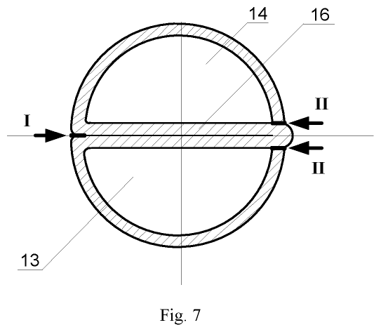

Second embodiment of the element of umbilical flexible tubing (FIGS. 6 and 7) is made of a metal strip 1 using a process including stages of shaping the strip by series of rollers from both edges or from the middle of the strip 1 and subsequent welding of longitudinal edges to the body of shaped strip 1 with formation of round two-channel string with two semicircular in cross section isolated channels 13 and 14 and partition 15 between them (see FIG. 6). Here the partition 15 is in fact the inner partition and simultaneously part of walls of both isolated channels 13 and 14. The partition 15 is located on the midline parallel to the reel axis, while weld seams are located as close as possible to the midline. To increase rigidity, a strengthened dividing partition 16 with thickness equal to double thickness of strip 1 can be applied (FIG. 7). Above two-channel welded umbilical flexible tubings with circular cross-section and partitions 15 or 16 (FIGS. 6 and 7) are presented only as examples. In order to increase cross-section of one channel at the expense of another channel (not shown), partition 15 or 16 may be re-arranged along a chord rather than diameter and/or the cross-section may be made elliptical (not shown). Due to rigidity of partitions 15 or 16, element of umbilical flexible tubing is self-aligning parallel to reel axis during spooling of the multi-channel string.

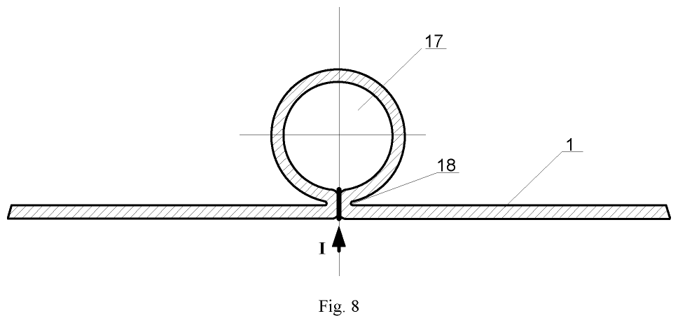

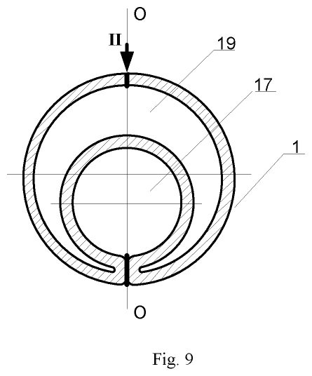

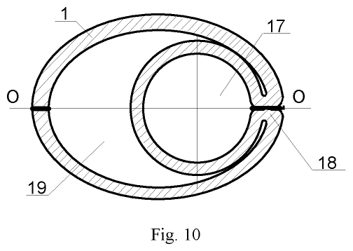

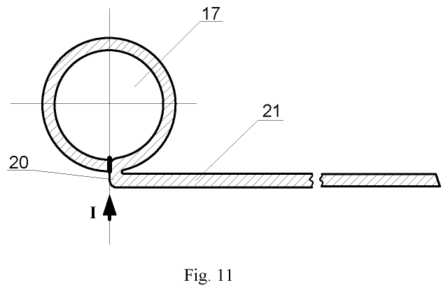

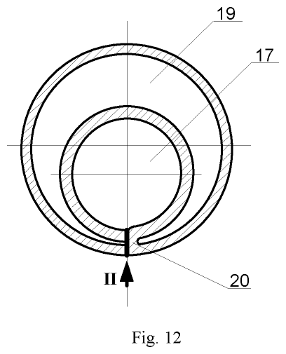

Third embodiment of the element of umbilical flexible tubing (FIGS. 8 to 10) is made of a metal strip 1 using a process including stages of: shaping the strip by series of rollers from the middle of the strip; subsequent welding of superposed parts of longitudinal edges to the body of shaped strip with formation of a small (smaller) cylindrical isolated channel 17, longitudinal welding of metal strip body along line of channel walls junction to form a jointing partition 18; further shaping the remaining part of strip 1 by series of rollers, and final welding of longitudinal edges of strip 1 with one another (FIG. 9) to form a larger isolated channel 19, the smaller channel 17 being located inside the larger channel 19 and rigidly attached to the larger channel by the jointing partition 18, said jointing partition together with center of smaller channel 17 and welding seams being located on a middle line parallel to the reel axis. The larger channel 19 may have the shape of ellipse in cross section (FIG. 10). Service lines such as electrical cables 10, fiber-optic lines 11, capillary tubes 12, etc. (not shown) may be placed inside smaller channel 17 or larger channel 19. Due to rigidity of jointing partition 18 and smaller channel 17, umbilical flexible tubing is self-aligning parallel to reel axis. As a special case of above embodiment, shaping of strip 1 is carried out by series of rollers from longitudinal edge of strip followed by welding of the longitudinal edge to the jointing partition 20 to form a small (smaller) cylindrical isolated channel 17 and lateral longitudinal lamella 21 (FIG. 11). Then, the remaining lateral longitudinal lamella 21 is further shaped by a series of rollers, followed by welding of the longitudinal edge of strip 1 to the jointing partition 20 (FIG. 12) to form a larger isolated channel 19, smaller channel 17 being located inside the larger channel 19 and rigidly attached thereto, said jointing partition together with center of smaller channel 17 and welding seams being located on a middle line parallel to the reel axis. As in the first embodiment, one of isolated channels can be used to accommodate an additional hydraulic channel, long-dimensional rod, electric power cable, etc. (not shown).

All above embodiments of element of umbilical flexible tubing do not exclude all necessary processing procedures required to produce long flexible pipes (coiled tubing) such as edge machining, heating, sizing, etc. In addition, all proposed embodiments of element of umbilical flexible tubing can be applied in both technological operations inside boreholes and fluid production facilities (artificial lift) and setups.

All embodiments of element of umbilical flexible tubing are applicable as either conventional coil tubing or flexible tubing with standard coiled tubing units but modified annular seal of stripper, injector tracks, guides, etc.

### INDUSTRIAL APPLICABILITY

The present invention makes it possible to significantly increase possibilities of coiled tubing units as well as the coiled tubing itself due to its multi-channel design and, consequently, multifunctionality.

1. An element of a lengthy umbilical flexible tubing, comprising at least two isolated channels, integrated into a single structure, wherein the isolated channels are joined together by a connecting partition, wherein the isolated channels and the connecting partition are formed from a single metal strip by shaping from both edges of the metal strip and/or from a center of the metal strip by bending the metal strip longitudinally with formation of walls of the isolated channels followed by subsequent welding of the longitudinal edges to the shaped metal strip, and wherein the connecting partition is made with holes.

2. The element according to claim 1, wherein welded seams, the connecting partition and central axes of the isolated channels are located on a midline of a cross section of the tubing.

3. The element according to claim 1, wherein a flexible service belt with connecting locking cams is mounted on the connecting partition, wherein locking cams coincide with the holes on the connecting partition, and the cams and holes form a locking element, and wherein the service belt is configured in such a way that electrical cables, wires, capillary tubes, fiber optic lines are placed therein.

4. The element according to claim 3, wherein a distance between two neighboring locking cams is at least two times longer than a distance between two neighboring holes in the connecting partition.

5. An element of a lengthy umbilical flexible tubing, comprising two isolated channels integrated into a single structure, wherein the isolated channels are joined together by a dividing partition, wherein the isolated channels and the dividing partition are formed from a single metal strip by bending the metal strip longitudinally with formation of walls of the isolated channels having a semi-circle form in cross-section and the dividing partition followed by subsequent welding of the longitudinal edges to the bended metal strip.

6. The element according to claim 5, wherein the dividing partition is also a part of the walls of the both isolated channels, and wherein the dividing partition and welded seams are located on a midline of a cross section of the tubing.

7. The element according to claim 6, wherein the dividing partition has a thickness that is about twice of a thickness of the metal strip.

8. An element of a lengthy umbilical flexible tubing, comprising two isolated channels integrated into a single structure, wherein the isolated channels are joined together by a jointing partition, wherein the isolated channels and the jointing partition are formed from a single metal strip by shaping from a center of the metal strip by bending the metal strip longitudinally with formation of an inner isolated channel followed by subsequent welding of contacting parts of the metal strip with formation of the jointing partition, and then shaping a remaining part of the metal strip with formation of an outer isolated channel followed by subsequent welding of longitudinal edges of the metal strip to the jointing partition.

9. An element of a lengthy umbilical flexible tubing, comprising two isolated channels integrated into a single structure, wherein the isolated channels are joined together by a jointing partition, wherein the isolated channels and the jointing partition are formed from a single metal strip by shaping from an edge of the metal strip with formation of an inner isolated channel followed by subsequent welding of contacting parts of the metal strip with formation of the jointing partition, and then shaping a remaining part of the metal strip with formation of an outer isolated channel followed by subsequent welding of longitudinal edges of the metal strip to the jointing partition.
